(19) United States
(12) Patent Application Publication
(10) Pub. No.: US 2025/0351044 A1
(43) Pub. Date: Nov. 13, 2025

(54) HANDOVER METHOD, HANDOVER SUPPORT METHOD, AND STORAGE MEDIUM STORING INSTRUCTIONS TO PERFORM HANDOVER SUPPORT METHOD

(71) Applicant: SK TELECOM CO., LTD., Seoul (KR)

(72) Inventor: Hyoungjoo LEE, Seoul (KR)

(21) Appl. No.: 18/861,347

(22) PCT Filed: May 2, 2023
(86) PCT No.: PCT/KR2023/005942

§ 371 Date: Aug. 6, 2025

(30) Foreign Application Priority Data
May 24, 2022 (KR) 10-2022-0063547
Apr. 26, 2023 (KR) 10-2023-0055038

(51) Int. Cl. H04W 36/36; H04B 17/318; H04W 84/06

(52) U.S. Cl. CPC H04W 36/362; H04B 17/328; H04W 84/06

(57) ABSTRACT

There is provided a handover support method to be performed by a wireless communication support device for supporting wireless communication for an aerial vehicle. The method comprises obtaining information on a preset corridor for the aerial vehicle; determining a combination of a source cell candidate and a target cell candidate for handover based on of the information on the preset corridor among wireless cells providing wireless communication for the aerial vehicle; and transmitting information on conditional handover (CHO) to the aerial vehicle according to the determined combination of the source cell candidate and the target cell candidate.

### TECHNICAL FIELD

The present disclosure relates to an aerial vehicle communication device, a handover method using the aerial vehicle communication device, a device supporting wireless communication for aerial vehicles, and a method of supporting handover using a device supporting wireless communication.

This application claims the priority date benefit of Korea Application 10-2022-0063547 filed on May 25, 2022, and Korea Application 10-2023-0055038 filed on Apr. 26, 2023, each of which is hereby incorporated by reference herein in its entirety. The entire content of the application on which this priority is based is incorporated by reference in the present application.

### BACKGROUND ART

Recently, urban air mobility (hereinafter, “UAM”) has been receiving greater attention, especially in developed nations, and South Korea also conducted a comprehensive empirical study on Korean UAM, which is going to be commercially available soon.

According to the Korean urban air transportation technology roadmap, it is expected that the operating altitude of UAM aerial vehicles will be approximately 300 to 600 meters, the maximum operating speed will be approximately 320 km/h, and UAM aerial vehicles will be operated along designated corridors.

Mobile communication base stations will be installed on corridors of UAM aerial vehicles in order to support data transmission and reception services for the UAM aerial vehicles, and each base station is responsible for a certain range of communications. Cell coverage, which represents the communication range of a base station, varies depending on the environment in which the base station is installed (e.g., city center, outskirts, or countryside), and for communication performance analysis, the 3GPP standard defines a base station spacing differently depending on the installation environment. In general, base station spacing is narrow in urban areas with many users and widens in rural areas with few users. The operations of UAM aerial vehicles basically consider high-density environments of urban areas, and even if the base station spacing is widened on the assumption of fewer users than in a ground network, handovers that an aerial vehicle crosses cell boundaries and moves to other cells are bound to occur frequently due to the fast aerial vehicle operation speed.

When a general handover procedure in a mobile communication environment is applied, a UAM aerial vehicle can transmit a measurement report on the strength of a wireless channel to a source cell, and a base station of the source cell can prepare a handover procedure when the signal strength of the source cell is lower than a specific threshold value or lower than the signal strength of a target cell, and when the preparation is completed, transmit a handover command to the UAM aerial vehicle. The UAM aerial vehicle can disconnect an uplink/downlink with the source cell and perform a procedure of connecting to the target cell, and after the connection procedure is performed smoothly, can transmit and receive data through an uplink/downlink newly connected to the target cell.

However, the maximum operating speed of the UAM aerial vehicle is about 320 km/h as mentioned above, which can lead to rapid changes in the wireless channel environment for both the source cell and target cell. When the UAM aerial vehicle passes the source cell and approaches the target cell, the signal strength of the source cell may suddenly decrease, and in this case, handover to the target cell needs to be performed rapidly.

However, due to a delay that occurs between the measurement report operation of the UAM aerial vehicle, the handover procedure preparation and handover command transmission of the source cell, and handover command reception of the UAM aerial vehicle, and starting of the procedure of connecting to the target cell, the UAM aerial vehicle needs to continuously perform data transmission/reception to/from the source cell having a wireless channel state that has already deteriorated through the uplink/downlink. This means that it may be difficult to obtain reliable UAM service communication quality in UAM operation scenarios where handovers frequently occur, and in particular, problems with transmission and reception of command & control (C2) information related to UAM operation safety are highly likely to occur.

### DETAILED DESCRIPTION OF INVENTION

### Technical Problems

According to an embodiment, the present disclosure provides a handover support method for supporting smooth handover in supporting wireless communication for an aerial vehicle such as UAM and a wireless communication support device that performs the same.

In addition, the present disclosure provides an aerial vehicle communication device and a handover method thereof by which an aerial vehicle such as a UAM can smoothly perform handover according to the support of a wireless communication support device.

The aspects of the present disclosure are not limited to the foregoing, and other aspects not mentioned herein will be clearly understood by those skilled in the art from the following description.

### Means for Solving Problems

In accordance with a first aspect of the present disclosure, there is provided a handover support method to be performed by a wireless communication support device for supporting wireless communication for an aerial vehicle, the handover support method comprises: obtaining information on a preset corridor for the aerial vehicle: determining a combination of a source cell candidate and a target cell candidate for handover based on of the information on the preset corridor among wireless cells providing wireless communication for the aerial vehicle; and transmitting information on conditional handover (CHO) to the aerial vehicle according to the determined combination of the source cell candidate and the target cell candidate.

In accordance with a second aspect of the present disclosure, there is provided a non-transitory computer readable storage medium storing computer executable instructions, wherein the instructions, when executed by a processor, cause the processor to perform a handover support method.

In accordance with a third aspect of the present disclosure, there is provided a handover support device for supporting wireless communication for an aerial vehicle, the handover support device comprises: an information acquisition unit configured to obtaining information on a preset corridor for the aerial vehicle: a memory configured to store one or more instructions: a processor configured to execute the one or more instructions stored in the memory, wherein the instructions, when executed by the processor, cause the processor to process information on the preset corridor; and a communication unit configured to communicate with the aerial vehicle, wherein the processor is configured to determine a combination of a source cell candidate and a target cell candidate for handover based on of the information on the preset corridor among wireless cells providing wireless communication for the aerial vehicle, and control the communication unit to transmit information on conditional handover (CHO) to the aerial vehicle according to the determined combination of the source cell candidate and the target cell candidate.

In accordance with a fourth aspect of the present disclosure, there is provided a handover method for wireless communication performed by an aerial vehicle communication device, the handover method comprises: receiving information on conditional handover from a wireless communication support device for the wireless communication: determining whether handover execution conditions are satisfied for a target cell candidate for the conditional handover among wireless cells of which service areas includes at least portions in a preset corridor; and performing handover from a source cell to the target cell candidate if the handover execution conditions are satisfied.

In accordance with a fifth aspect of the present disclosure, there is provided a non-transitory computer readable storage medium storing computer executable instructions, wherein the instructions, when executed by a processor, cause the processor to perform a handover method.

In accordance with a sixth aspect of the present disclosure, there is provided a communication device for an aerial vehicle to perform handover among wireless cells providing wireless communication, the communication device comprises: a communication unit configured to communicate with m a wireless communication support device for the wireless communication; a memory configured to store one or more instructions; and a processor configured to execute the one or more instructions stored in the memory, wherein the instructions, when executed by the processor, cause the processor to control the communication unit to perform the handover, wherein the processor is configured to receive information on conditional handover from a wireless communication support device through the communication unit, determine whether handover execution conditions are satisfied for a target cell candidate for the conditional handover among wireless cells of which service areas includes at least portions in a preset corridor; and perform handover from a source cell to the target cell candidate if the handover execution conditions are satisfied.

### Effects of Invention

According to an embodiment, in supporting wireless communication for an aerial vehicle such as UAM, smooth handover is supported. To this end, a combination of a source cell candidate and a target cell candidate is determined based on corridor information of the aerial vehicle, and then information on conditional handover is transmitted to the aerial vehicle according to the determined combination of the source cell candidate and the target cell candidate, thereby skipping a measurement report operation and a handover command transmission procedure and performing rapid handover processing according to handover order on a corridor to prevent delay during handover.

### BRIEF DESCRIPTION OF THE DRAWINGS

FIG. 1 is a configuration diagram of a UAM operation system including an aerial vehicle communication device and a wireless communication support device according to an embodiment of the present disclosure.

FIG. 2 is a configuration diagram of the wireless communication support device capable of constituting the UAM operation system of FIG. 1.

FIG. 3 is a configuration diagram of the aerial vehicle communication device capable of constituting the UAM operation system of FIG. 1.

FIG. 4 is a flowchart for describing a signal processing and information transmission process of the aerial vehicle communication device and the wireless communication support device that can constitute the UAM operation system of FIG. 1.

FIG. 5 is a diagram illustrating corridors of a plurality of UAM aerial vehicles and wireless cells including at least portions of the corridors as service areas.

FIG. 6 and FIG. 7 show an example in which a handover procedure may vary depending on morphological differences in serving cells located on a corridor of a UAM aerial vehicle equipped with the aerial vehicle communication device.

FIG. 8 is a flowchart for describing another example of the signal processing and information transmission process of the aerial vehicle communication device and the wireless communication support device that can constitute the UAM operation system of FIG. 1.

FIG. 9 is a flowchart for describing a process of selecting handover execution conditions when the signal processing and information transmission process of FIG. 8 is applied to the UAM operation system of FIG. 1.

### BEST MODE FOR CARRYING OUT THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

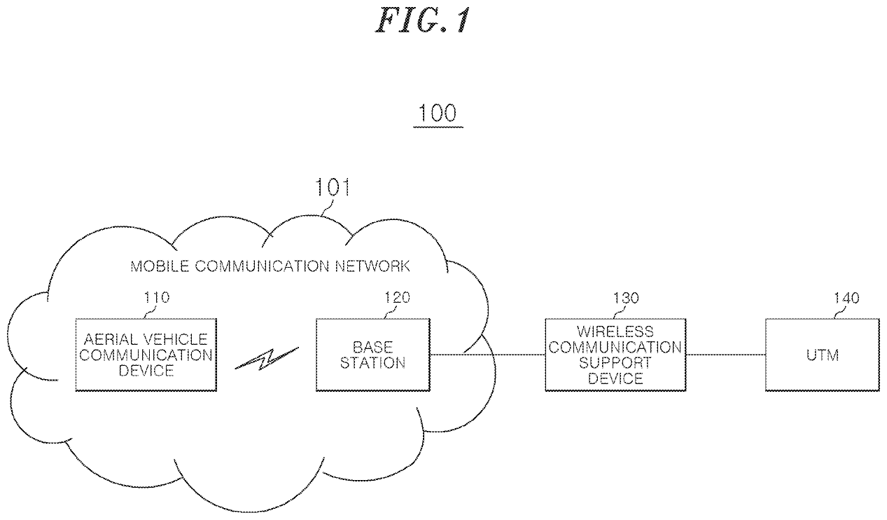

FIG. 1 is a configuration diagram of a UAM operation system including an aerial vehicle communication device and a wireless communication support device according to an embodiment of the present disclosure.

Referring to FIG. 1, the UAM operation system 100 may include an aerial vehicle communication device 110, a base station 120, a wireless communication support device 130, and unmanned aircraft system traffic management (UTM) 140.

The aerial vehicle communication device 110 may be mounted on a UAM aerial vehicle and may use a mobile communication network 101 through the base station 120 in an environment in which wireless communication is supported by the wireless communication support device 130. This aerial vehicle communication device 110 may be operated along a corridor according to corridor information preset in a provider of services for UAM (PSU) within the UTM 140 and may sequentially perform handovers to wireless cells of the mobile communication network 101, which include at least portions of the corridor as service areas. The aerial vehicle communication device 110 will be described with reference to FIG. 3.

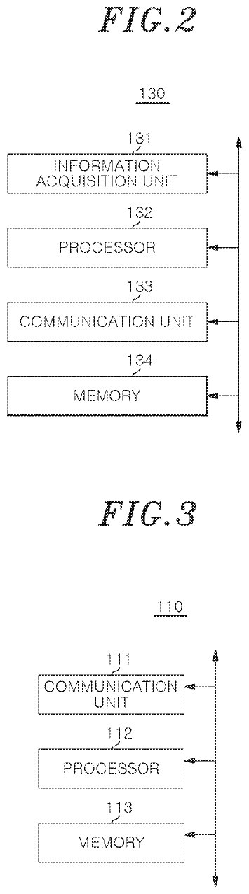

The wireless communication support device 130 may determine a combination of a source cell candidate and a target cell candidate among wireless cells that provide wireless communication for the UAM aerial vehicle on which the aerial vehicle communication device 110 is mounted and a handover order based on corridor information preset in the UTM 140, and transmit information on conditional handover to the aerial vehicle communication device 110 through the base station 120 (e.g., the base station of a source cell) according to the determined combination of the source cell candidate and the target cell candidate. For example, when the mobile communication network 101 is implemented in 3GPP 4G/5G, the wireless communication support device 130 may be a mobility management entity (MME) or another entity constituting a core network. The wireless communication support device 130 will be described with reference to FIG. 2.

The PSU in the UTM 140 may determine and set corridors of UAM aerial vehicles equipped with the aerial vehicle communication device 110 based on relevant information such as departure points, destinations, flight times, and weather environment of the UAM aerial vehicles and provide corridor information of the UAM aerial vehicles, set as described above, to the wireless communication support device 130.

FIG. 2 is a configuration diagram of the wireless communication support device 130 capable of constituting the UAM operation system 100 of FIG. 1.

Referring to FIG. 2, the wireless communication support device 130 may include an information acquisition unit 131, a processor 132, and a communication unit 133, and may further include a memory 134.

The information acquisition unit 131 may obtain corridor information preset for a UAM aerial vehicle equipped with the aerial vehicle communication device 110 from the UTM 140, and provide the obtained corridor information to the processor 132. Here, the preset corridor information for the UAM aerial vehicle may be obtained in advance and stored in the memory 134, and in this case, the information acquisition unit 131 may extract the corridor information from the memory 134 and provide the same to the processor 132.

The communication unit 133 performs communication with the aerial vehicle communication device 110 mounted on the UAM aerial vehicle under the control of the processor 132.

The memory 134 may store a computer program including at least one instruction for instructing the processor 132 to perform a handover support method according to an embodiment of the present disclosure. Additionally, as mentioned above, corridor information may be stored in the memory 134.

The processor 132 processes the corridor information provided from the information acquisition unit 131. The processor 132 loads and executes the computer program stored in the memory 134 to determine a combination of a source cell candidate and a target cell candidate among wireless cells that provide wireless communication to the aerial vehicle communication device 110 mounted on the UAM aerial vehicle based on the corridor information. Here, the processor 132 may determine a handover order for a plurality of combinations. In addition, the processor 132 controls the communication unit 133 to transmit information on conditional handover to the aerial vehicle communication device 110 mounted on the UAM aerial vehicle according to the determined combination of the source cell candidate and the target cell candidate. Here, the processor 132 may select serving cells from among wireless cells that include at least portions of the corridor according to the corridor information as service areas. For example, the corridor information may include latitude and longitude information regarding a plurality of locations on the corridor, and the processor 132 may determine whether at least portions of the corridor are included in service areas based on a result of comparison between information on service areas of wireless cells with the latitude and longitude information.

In addition, the processor 132 may obtain real-time corridor information with respect to the UAM aerial vehicle equipped with the aerial vehicle communication device 110, update the combination of the source cell candidate and the target cell candidate when the corridor of the UAM aerial vehicle has changed on based on a result of comparison between the preset corridor information and the real-time corridor information, and transmit information on the conditional handover updated according to the updated combination of the source cell candidate and the target cell candidate to the aerial vehicle communication device 110 mounted on the UAM aerial vehicle.

In addition, when the aerial vehicle communication device 110 or the UAM aerial vehicle has transmitted a report related to location information and time information and the wireless communication support device 130 has obtained the report, the processor 132 may additionally include information on a handover method selected according to the report of the UAM aerial vehicle in handover execution conditions included in the information on conditional handover. For example, the handover execution conditions may include selecting one of handover based on the location information of the UAM aerial vehicle, the time information of the UAM aerial vehicle, and an RSRP value of a target cell candidate.

Additionally, when the processor 132 updates the combination of the source cell candidate and the target cell candidate, the handover order may be updated together. In addition, the processor 132 may determine that the corridor of the UAM aerial vehicle has changed when the UAM aerial vehicle does not wirelessly connect to the source cell candidate or the target cell candidate included in the information on conditional handover or when the UAM aerial vehicle wirelessly connects to a cell other than the source cell candidate and the target cell candidate.

For example, the information on conditional handover may include information on one or more target cell candidates adjacent to the UAM aerial vehicle and handover execution conditions, and the handover execution conditions may include an instruction for handover to a target cell candidate having a maximum received signal reference power (RSRP) value among the one or more target cell candidates. Alternatively, the information on conditional handover may include information on fallback to a source cell when handover from the source cell to a target cell is delayed or fails. Alternatively, the information on conditional handover may include information on a plurality of target cell candidates and handover execution conditions corresponding to a plurality of consecutive handovers according to handover order, and the handover execution conditions may include an instruction for handover to a target cell candidate having a maximum RSRP value among the plurality of target cell candidates.

FIG. 3 is a configuration diagram of the aerial vehicle communication device 110 capable of constituting the UAM operation system 100 of FIG. 1.

Referring to FIG. 3, the aerial vehicle communication device 110 may include a communication unit 111 and a processor 112 and may further include a memory 113. The aerial vehicle communication device 110 may be mounted on a UAM aerial vehicle.

The communication unit 111 may perform wireless communication with the wireless communication support device 130 through the base station 120 and may perform handover to serving cells during wireless communication.

The memory 113 may store a computer program including at least one instruction for instructing the processor 112 to perform a handover method for wireless communication according to an embodiment of the present disclosure.

The processor 112 may control handover performed by the communication unit 111 by loading and executing the computer program stored in the memory 113, and various processing results obtained by the processor 112 may be stored in the memory 113.

In addition, the processor 112 may receive information on conditional handover from the wireless communication support device 130 through the communication unit 111, determine whether handover execution conditions are satisfied for a target cell candidate for conditional handover among wireless cells including at least portions of a corridor according to preset corridor information of the UAM aerial vehicle as service areas, and if the handover execution conditions are satisfied, control the communication unit 111 to perform handover from a source cell to the target cell candidate.

For example, information on conditional handover may include information on fallback to a source cell when handover from the source cell to a target cell is delayed or fails, and the processor 112 may fall back to the source cell if delay or failure of handover to the target cell occurs during handover.

In addition, the information on conditional handover may include information on a plurality of target cell candidates adjacent to the UAM aerial vehicle, and the processor 112 may perform handover to a target cell candidate having a maximum RSRP value among the plurality of target cell candidates when performing handover.

In addition, the information on conditional handover may include information on a plurality of target cell candidates corresponding to a plurality of consecutive handovers according to a handover order determined based on corridor information from among wireless cells that provide wireless communication to the aerial vehicle communication device 110, and the processor 112 may perform handover to a target cell candidate having a maximum RSRP value among the plurality of target cell candidates when performing handover. Alternatively, when a handover delay or handover failure occurs for a high-priority target cell candidate according to the handover order, the processor 112 may perform handover to a low-priority target cell based on information on a plurality of target cells corresponding to a plurality of handovers.

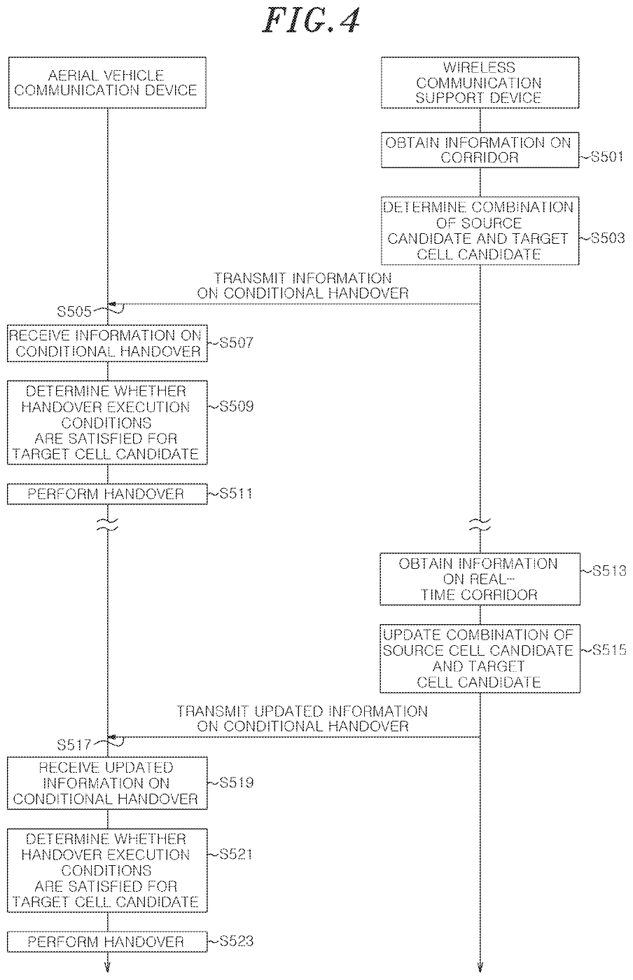

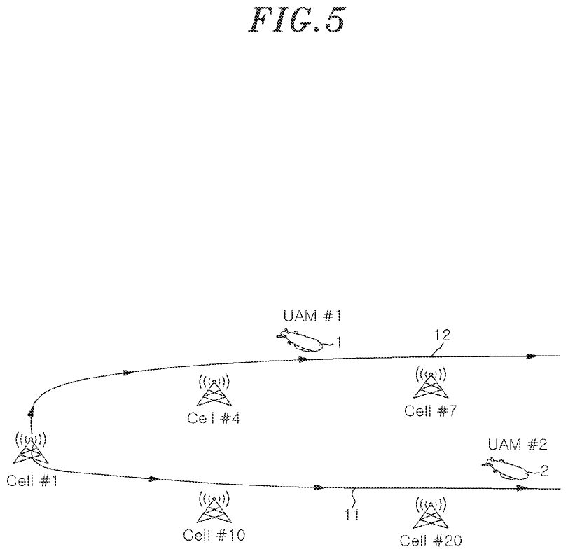

FIG. 4 is a flowchart for describing a signal processing and information transmission process of the aerial vehicle communication device 110 and the wireless communication support device 130 that can constitute the UAM operation system 100 of FIG. 1. Referring to FIG. 4, a handover method using the aerial vehicle communication device 110 and a handover support method using the wireless communication support device 130 will be described.

FIG. 5 is a diagram illustrating corridors of a plurality of UAM aerial vehicles and wireless cells including at least portions of the corridors as service areas.

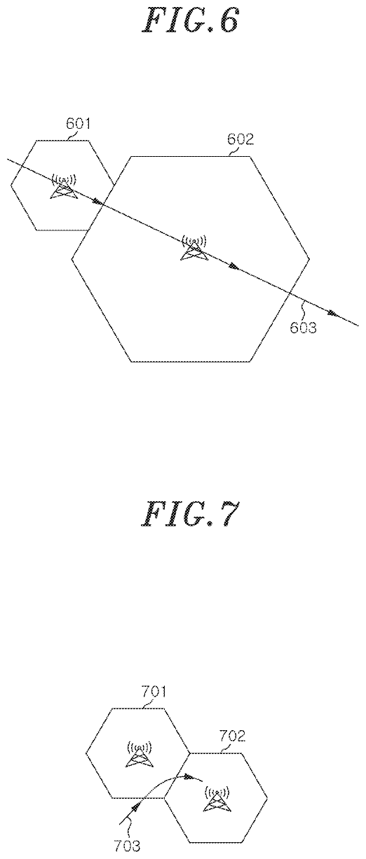

FIG. 6 and FIG. 7 show an example in which a handover procedure may vary depending on morphological differences in serving cells located on a corridor of a UAM aerial vehicle equipped with the aerial vehicle communication device 110.

Hereinafter, an example in which a handover procedure is performed on serving cells while the UAM operation system 100 including the aerial vehicle communication device 110 and the wireless communication support device 130 operates UAM aerial vehicles will be described with reference to FIG. 1 to FIG. 7.

First, the information acquisition unit 131 of the wireless communication support device 130 obtains preset corridor information of UAM aerial vehicles from the UTM 140 and provides the obtained corridor information to the processor 132 of the wireless communication support device 130. Alternatively, the information acquisition unit 131 may extract corridor information of UAM aerial vehicles obtained in advance from the UTM 140 and stored in the memory 134 of the wireless communication support device 130, and provide the extracted corridor information to the processor 132 (S501).

Then, the processor 132 determines a combination of a source cell candidate and a target cell candidate based on the corridor information among wireless cells that provide wireless communication to the aerial vehicle communication device 110 mounted on a UAM aerial vehicle. Here, a handover order may be determined for a plurality of combinations.

The handover order that may be determined by the processor 132 is described with reference to FIG. 5. As illustrated in FIG. 5, a first UAM aerial vehicle 1 may be operated through a second corridor 12 starting from a wireless cell Cell #1, and a second UAM aerial vehicle 2 may be operated through a first corridor 11 starting from the wireless cell Cell #1. In this case, the processor 132 may determine that the aerial vehicle communication device 110 mounted on the first UAM aerial vehicle 1 sequentially performs a handover procedure from the source cell Cell #1 to a target cell Cell #4 and a handover procedure from the source cell Cell #4 to a target cell Cell #7. In addition, the processor 132 may determine that the aerial vehicle communication device 110 mounted on the second UAM aerial vehicle 2 sequentially performs a handover procedure from the source cell Cell #1 to a target cell Cell #10 and a handover procedure from the source cell Cell #10 to a target cell Cell #20 (S503).

Subsequently, the processor 132 controls the communication unit 133 to transmit information on conditional handover to the aerial vehicle communication device 110 mounted on the UAM aerial vehicle according to the combination of the source cell candidate and the target cell candidate determined in step S503, and the communication unit 133 transmits the information on conditional handover to the aerial vehicle communication device 110 mounted on the UAM aerial vehicle under the control of the processor 132 (S505).

The information on conditional handover transmitted from the wireless communication support device 130 to the aerial vehicle communication device 110 in step S505 may include information on target cell candidates for handover and handover execution conditions, and the handover execution conditions may include a case in which the RSRP value of a source cell is smaller than the RSRP value of a target cell candidate. In addition, the information on conditional handover may include information on a plurality of target cell candidates adjacent to the UAM aerial vehicle and handover execution conditions, and the handover execution conditions may include an instruction for handover to a target cell candidate having a maximum RSRP value among the plurality of target cell candidates. Additionally, the information on conditional handover may include information on fallback to a source cell in case of delay or failure of handover from the source cell to a target cell. Additionally, the information on conditional handover may include information on a plurality of target cell candidates corresponding to a plurality of consecutive handovers according to handover order. For example, the aerial vehicle communication device 110 mounted on the first UAM aerial vehicle 1 may be provided with not only information for handover from the source cell Cell #1 to the target cell Cell #4 but also information for handover to the target cell Cell #7 and handover execution conditions in advance, and the handover execution conditions may include an instruction for handover to a target cell having a larger RSRP value between the target cell Cell #4 and the target cell Cell #7.

Subsequently, the communication unit 111 of the aerial vehicle communication device 110 mounted on the UAM aerial vehicle receives information on conditional handover transmitted from the wireless communication support device 130 through the base station 120 and provides the received information on conditional handover to the processor 112 of the aerial vehicle communication device 110 (S507).

Then, the processor 112 determines whether the handover execution conditions are satisfied for the target cell candidate included in the information on conditional handover provided from the wireless communication support device 130 in step S505 (S509), and controls the communication unit 111 such that handover from the source cell to the target cell candidate is performed if the target cell candidate satisfies the handover execution conditions.

Here, as described above, the handover execution conditions including the information on conditional handover transmitted from the wireless communication support device 130 to the aerial vehicle communication device 110 in step S505 may include a case in which the RSRP value of the source cell is less than the RSRP value of the target cell candidate. For example, the processor 112 of the aerial vehicle communication device 110 mounted on the first UAM aerial vehicle 1 may control the communication unit 111 such that handover from the source cell Cell #1 to the target cell Cell #4 is performed if the RSRP value of the source cell Cell #1 is less than the RSRP value of the target cell Cell #4.

Alternatively, the information on conditional handover transmitted from the wireless communication support device 130 to the aerial vehicle communication device 110 in step S505 may include information on a plurality of target cell candidates adjacent to the UAM aerial vehicle and handover execution conditions, and the handover execution conditions may include an instruction for handover to a target cell candidate having a maximum RSRP value among the plurality of target cell candidates. For example, the information on conditional handover transmitted to the aerial vehicle communication device 110 mounted on the first UAM aerial vehicle 1 may include the target cell Cell #7 and the target cell Cell #20 as target cell candidates, and the processor 112 of the aerial vehicle communication device 110 may control the communication unit 111 such that handover from the source cell Cell #4 to the target cell Cell #7 if the RSRP value of the target cell Cell #7 is greater than the RSRP value of the source cell Cell #20.

Alternatively, the information on conditional handover transmitted from the wireless communication support device 130 to the aerial vehicle communication device 110 in step S505 may include information on fallback to a source cell in case of delay or failure of handover from the source cell to a target cell. For example, the processor 112 of the aerial vehicle communication device 110 mounted on the first UAM aerial vehicle 1 may control the communication unit 111 such that fallback to the source cell Cell #1 is performed when handover from the source cell Cell #1 to the target cell Cell #4 is delayed or fails.

Alternatively, the information on conditional handover transmitted from the wireless communication support device 130 to the aerial vehicle communication device 110 in step S505 may include information on a plurality of target cell candidates corresponding to a plurality of consecutive handovers according to handover order. For example, the processor 112 of the aerial vehicle communication device 110 mounted on the first UAM aerial vehicle 1 may control the communication unit 111 such that direct handover from the source cell Cell #1 to the target cell Cell #7 is performed without passing through the source cell Cell #4 when handover from the source cell Cell #1 to the target cell Cell #4 is delayed or fails. As illustrated in FIG. 6, when a service area 601 of a serving cell located first on a corridor 603 is much narrower than a service area 603 of a serving cell located following the service area 601, handover to the target cell candidate having the service area 601 may fail, and in this case, handover to the target cell candidate having the service area 602 can be performed. Alternatively, as illustrated in FIG. 7, when a corridor 703 does not pass through the central part of a service area 701, handover to a target cell candidate having the service area 701 may fail, and in this case, handover to a target cell candidate having a service area 702 can be performed (S511).

Meanwhile, a corridor of a UAM aerial vehicle equipped with the aerial vehicle communication device 110 may be suddenly changed during operation. For example, if there is a risk of collision with an unnecessary object on a preset corridor of the UAM aerial vehicle, the corridor may be changed. In preparation for this case, the processor 132 of the wireless communication support device 130 may obtain real-time corridor information from the aerial vehicle communication device 110 mounted on the UAM aerial vehicle through the communication unit 133 or the information acquisition unit 131 (S513), and update a combination of a source cell candidate and a target cell candidate when the corridor of the UAM aerial vehicle has changed based on a result of comparison between the preset corridor information and the real-time corridor information. For example, if a UAM aerial vehicle does not wirelessly connect to a source cell candidate or a target cell candidate included in the information on conditional handover or if the UAM aerial vehicle wirelessly connects to a cell other than the source cell candidate and the target cell candidate, the processor 132 may determine that the corridor of the UAM aerial vehicle has changed (S515).

In this case, the communication unit 133 of the wireless communication support device 130 transmits updated information on conditional handover to the aerial vehicle communication device 110 mounted on the UAM aerial vehicle under the control of the processor 132 (S517), the communication unit 111 of the aerial vehicle communication device 110 transmits the updated information on conditional handover to the processor 112 (S519).

Then, the processor 112 of the aerial vehicle communication device 110 mounted on the UAM aerial vehicle determines whether handover execution conditions are satisfied for the target cell candidate included in the information on conditional handover provided from the wireless communication support device 130 in step S517 (S521), and if the target cell candidate satisfies the handover execution conditions, controls the communication unit 111 such that handover from the source cell to the target cell candidate is performed (S523). Since this handover procedure is performed similarly to steps S509 and S511, detailed description thereof will be omitted.

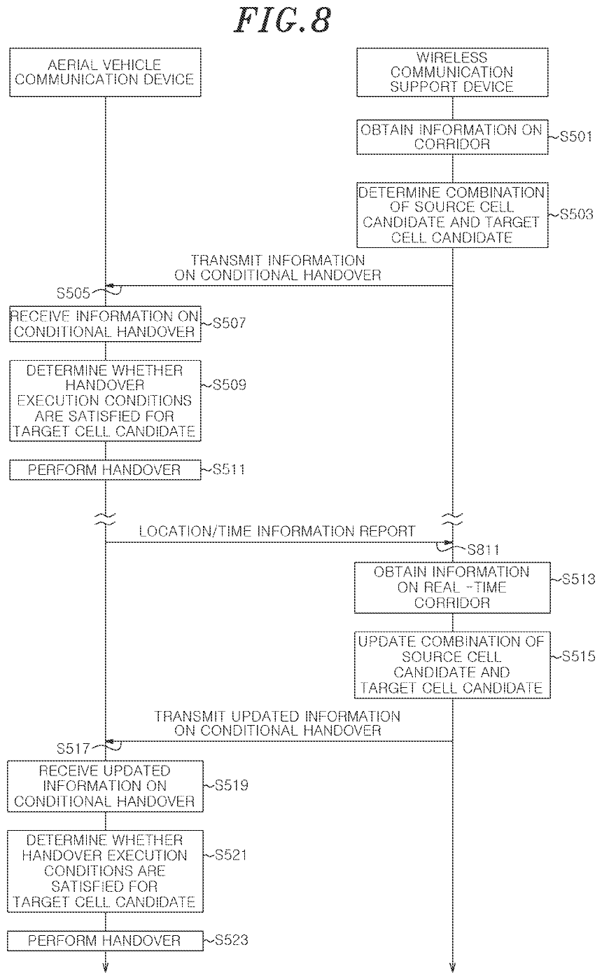

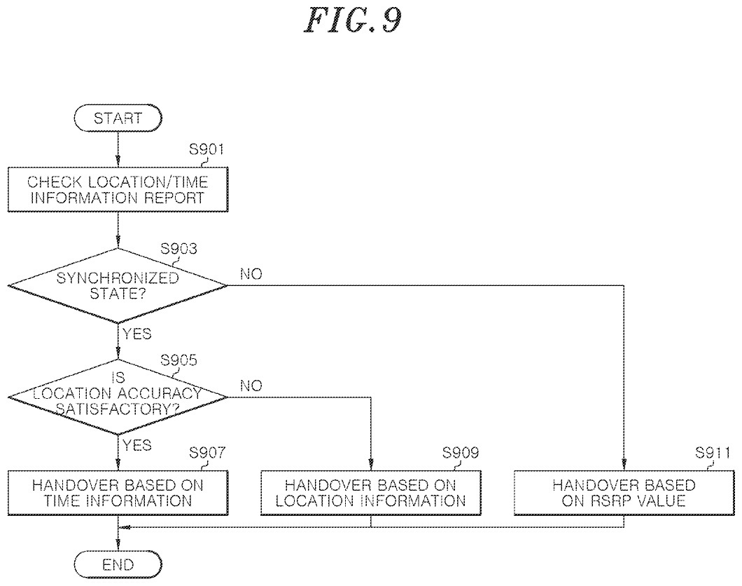

FIG. 8 is a flowchart for describing another example of the signal processing and information transmission process of the aerial vehicle communication device 110 and the wireless communication support device 130 that can constitute the UAM operation system 100 of FIG. 1, and FIG. 9 is a flowchart for describing a process of selecting handover execution conditions when the signal processing and information transmission process of FIG. 8 is applied to the UAM operation system of FIG. 1. First, comparing the flowchart of FIG. 8 with the flowchart of FIG. 4, it can be ascertained that process S811 in which the aerial vehicle communication device 110 transmits a report related to location information and time information of a UAM aerial vehicle and the wireless communication support device 130 receives the report during operation of the UAM aerial vehicle is added.

According to the embodiment of FIG. 8, when the processor 132 of the wireless communication support device 130 obtains real-time corridor information through the communication unit 133 or the information acquisition unit 131 in step S513, the report related to the location information and time information of the UAM aerial vehicle provided by the aerial vehicle communication device 110 can be obtained in step S811.

In this case, the processor 132 may update a combination of a source cell candidate and a target cell candidate by reflecting the report related to the location information and time information of the UAM aerial vehicle (S515), and may transmit information on conditional handover updated in this manner to the aerial vehicle communication device 110 mounted on the UAM aerial vehicle (S517). Here, according to one embodiment, the report of the UAM aerial vehicle in step S811 is reflected in the process of transmitting the information on conditional handover in steps S515 and S517. If step S811 is performed before step S503, the report of the UAM aerial vehicle in step S811 may be reflected in the process of transmitting the information on conditional handover in steps S503 and S505. This may mean that the wireless communication support device 130 can obtain the report related to the location information and time information of the UAM aerial vehicle separately from the real-time corridor information and reflect this in the information on conditional handover.

According to the embodiment of FIG. 8, the information on conditional handover provided in step S517 may include information on one or more target cell candidates adjacent to the UAM aerial vehicle and handover execution conditions, and the handover execution conditions included therein may include selecting one of handover based on the location information of the UAM aerial vehicle, the time information of the UAM aerial vehicle, and the RSRP value of a target cell candidate according to the report of the UAM aerial vehicle. An embodiment in which the processor 132 of the wireless communication support device 130 selects one of a plurality of handover methods in this manner is shown in the flowchart of FIG. 9.

Referring to FIG. 9, the processor 132 of the wireless communication support device 130 checks the report related to the location information and time information of the UAM aerial vehicle obtained in step S811. For example, the report may include information on whether the UAM aerial vehicle has properly received a global positioning system (GPS) signal and/or a global navigation satellite system (GNSS) signal, and information on the location and/or time have been synchronized with respect to the received GPS signal and/or GNSS signal (S901).

Then, the processor 132 can check whether the UAM aerial vehicle that has transmitted the report is synchronized to the GPS signal or GNSS signal and check whether location accuracy is better than preset reference accuracy. For example, the location accuracy may be included in the report related to the location information and time information and provided by the UAM aerial vehicle (S903 and S905).

Depending on the checking results of steps S903 and S905, the processor 132 may include information on selection of one of handover based on the location information of the UAM aerial vehicle, the time information of the UAM aerial vehicle, and the RSRP value of a target cell candidate in the information on conditional handover and transmit the same.

Here, the processor 132 may select handover based on the RSRP value of the target cell candidate before the UAM aerial vehicle is synchronized to the GPS signal or the GNSS signal. This case may correspond to a case in which the UAM aerial vehicle cannot properly receive the GPS signal or the GNSS signal, and in this case, handover based on the location information and/or the time information cannot be performed, but handover based on RSRP values may be performed (S911).

Additionally, after the UAM aerial vehicle is synchronized to the GPS signal or the GNSS signal, the processor 132 may select handover based on the time information of the UAM aerial vehicle if the location accuracy of the UAM aerial vehicle is below a preset level. In this case, it is difficult for the UAM aerial vehicle to receive signals due to operations of other UAM aerial vehicles in a high-density environment in which there are many other adjacent UAM aerial vehicle, or the UAM aerial vehicle may rotate. At this time, the location accuracy of the UAM aerial vehicle is likely to significantly fluctuate, but time synchronization is likely to be maintained, and thus handover based on time information can be selected. Alternatively, the location accuracy received from the UAM aerial vehicle may differ from an expected value by a certain level, but is not at a level to determine that the UAM aerial vehicle has deviated from the corridor. In this case, the location accuracy may be low, and thus handover based on time information can be selected (S907).

On the other hand, the processor 132 may select handover based on the location information of the UAM aerial vehicle if the location accuracy of the UAM aerial vehicle is higher than the preset level after the UAM aerial vehicle is synchronized to the GPS signal or the GNSS signal. Handover based on time information may cause changes in a navigation speed due to environmental factors such as weather or wind, and thus when the location accuracy is high, deterioration in communication quality due to handover can be minimized by selecting handover based on location information (S909).

Thereafter, the processor 112 of the aerial vehicle communication device 110 may perform steps S519 to S523 as described above with reference to FIG. 4. Here, during handover in step S523, the information on conditional handover in which the location/time information report in step S811 has been reflected is transmitted in step S517, and thus handover of the aerial vehicle communication device 110 may be performed in various manners.

The aerial vehicle communication device 110 may determine whether the handover execution conditions included in the information on conditional handover are satisfied differently depending on the situation.

When the aerial vehicle communication device 110 performs handover based on RSRP values, the criteria for determining whether the handover execution conditions are satisfied may be adjusted according to a reference signal transmission period and average number of times for each cell. For example, if RSRP has not yet been measured a sufficient number of times or there are problems in transmission with respect to the serving cell other than a signal strength, handover to a target cell can be performed more rapidly by adjusting the criteria for determining whether the handover execution conditions are satisfied.

If there is a plurality of target cell candidates that satisfy the handover execution conditions based on the information on conditional handover, handover to a target cell with the highest satisfaction with the handover execution conditions among the plurality of target cell candidates may be performed.

Fallback to a source cell when handover to a target cell fails or is delayed has been described above. In this case, the aerial vehicle communication device 110 may not immediately fall back to the source cell, but may check whether there is a cell that satisfies the handover execution conditions based on the information on conditional handover among other target cell candidates and perform handover to the corresponding target cell.

Meanwhile, a computer program including instructions for causing the processor to perform each step included in the handover method for wireless communication performed by the aerial vehicle communication device 110 and the handover support method performed by the wireless communication support device 130 according to the above-described embodiment may be implemented.

In addition, the computer program including instructions for causing the processor to perform each step included in the handover method for wireless communication performed by the aerial vehicle communication device 110 and the handover support method performed by the wireless communication support device 130 according to the above-described embodiment may be recorded on a computer-readable recording medium.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

### INDUSTRIAL APPLICABILITY

According to an embodiment of the present disclosure, in supporting wireless communication for aerial vehicles such as UAM, smooth handover is supported by skipping a measurement report operation and a handover command transmission procedure and rapidly processing handover according to handover order on a corridor to prevent delay from occurring during handover. This embodiment of the present disclosure can be used in various systems and related technical fields that support wireless communication for aerial vehicles such as UAM.

The invention claimed is:

1. A handover support method to be performed by a wireless communication support device for supporting wireless communication for an aerial vehicle, the handover support method comprising:
obtaining information on a preset corridor for the aerial vehicle;
determining a combination of a source cell candidate and a target cell candidate for handover based on the information on the preset corridor among wireless cells providing wireless communication for the aerial vehicle; and
transmitting information on conditional handover (CHO) to the aerial vehicle according to the determined combination of the source cell candidate and the target cell candidate.

2. The handover support method of claim 1, wherein the source cell candidate and the target cell candidate are determined among wireless cells of which service areas includes at least portions in the preset corridor.

3. The handover support method of claim 2, wherein the information on the preset corridor includes latitude information and longitude information on a plurality of locations on the preset corridor, and
wherein, whether at least portions in the preset corridor are included as service areas is determined based on a result of comparison between information on service areas of the wireless cells and the latitude information and the longitude information.

4. The handover support method of claim 1, further comprising:
obtaining information on real-time corridor for the aerial vehicle;
updating the combination of the source cell candidate and the target cell candidate based on a result of comparison between the information on the preset corridor and the information on the real-time corridor; and
transmitting information on conditional handover updated according to the updated combination of the source cell candidate and the target cell candidate to the aerial vehicle.

5. The handover support method of claim 4, wherein, if the aerial vehicle is not wirelessly connected to the source cell candidate or the target cell candidate included in the information on conditional handover or if the aerial vehicle wirelessly is connected to a cell other than the source cell candidate and the target cell candidate, it is determined that the corridor of the aerial vehicle has changed.

6. The handover support method of claim 1, further comprising obtaining a report related to location information and time information of the aerial vehicle,
wherein the information on conditional handover includes information on one or more target cell candidates adjacent to the aerial vehicle and handover execution conditions, and
wherein the handover execution conditions include selection of one of handover based on the location information of the aerial vehicle, the time information of the aerial vehicle, and a received signal reference power (RSRP) value of the target cell candidate according to the report.

7. The handover support method of claim 6, wherein handover based on the RSRP value of the target cell candidate is selected before the aerial vehicle is synchronized to a Global Positioning System (GPS) signal or a Global Navigation Satellite System (GNSS) signal.

8. The handover support method of claim 7,
wherein the handover execution conditions include an instruction for handover to a target cell candidate having a maximum RSRP value among the one or more target cell candidates.

9. The handover support method of claim 7, wherein the information on conditional handover includes information on fallback to a source cell in case of delay of handover from the source cell to a target cell or failure in the handover from the source cell to the target cell.

10. The handover support method of claim 7, wherein the information on conditional handover includes information on a plurality of target cell candidates corresponding to a plurality of consecutive handovers and handover execution conditions, and
wherein the handover execution conditions include an instruction for handover to a target cell candidate having a maximum RSRP value among the plurality of target cell candidates.

11. The handover support method of claim 6, wherein one of handover based on the location information of the aerial vehicle and the time information of the aerial vehicle is selected depending on whether location accuracy of the aerial vehicle is equal to or higher than a preset level after the aerial vehicle is synchronized to a GPS signal or a GNSS signal.

12. A non-transitory computer readable storage medium storing computer executable instructions, wherein the instructions, when executed by a processor, cause the processor to perform a handover support method, the handover support method comprising:
obtaining information on a preset corridor for the aerial vehicle;
determining a combination of a source cell candidate and a target cell candidate for handover based on the information on the preset corridor among wireless cells providing wireless communication for the aerial vehicle; and
transmitting information on conditional handover (CHO) to the aerial vehicle according to the determined combination of the source cell candidate and the target cell candidate.

13. (canceled)

14. A handover method for wireless communication performed by an aerial vehicle communication device, the handover method comprising:
receiving information on conditional handover from a wireless communication support device for the wireless communication;
determining whether handover execution conditions are satisfied for a target cell candidate for the conditional handover among wireless cells of which service areas includes at least portions in a preset corridor; and
performing handover from a source cell to the target cell candidate if the handover execution conditions are satisfied.

15. The handover method of claim 14, wherein the information on conditional handover includes information on one or more target cell candidates adjacent to the aerial vehicle and handover execution conditions, and
wherein the performing handover includes selecting one of handover based on location information of the aerial vehicle, time information of the aerial vehicle, and a received signal reference power (RSRP) value of the target cell candidate according to the handover execution conditions.

16. The handover method of claim 15, wherein, when handover based on the RSRP value of the target cell candidate is selected, handover to a target cell candidate having a maximum RSRP value among the one or more target cell candidates is performed.

17. The handover method of claim 14, wherein the information on conditional handover includes information on fallback to a source cell in case of delay of handover from the source cell to a target cell or failure in the handover from the source cell to the target cell, and
wherein the handover method further comprising falling back to the source cell when handover to the target cell is delayed or fails in the performing handover.

18. The handover method of claim 14, wherein the information on conditional handover includes information on a plurality of target cell candidates corresponding to a plurality of consecutive handovers, and
wherein the performing handover includes performing handover to a target cell candidate having a maximum RSRP value among the plurality of target cell candidates.

19. (canceled)

20. (canceled)
